(19) United States
(12) Patent Application Publication
(10) Pub. No.: US 2010/0300446 A1
(43) Pub. Date: Dec. 2, 2010

(54) SYSTEMS AND METHODS FOR PROTECTING COMPONENTS OF A BREATHING ASSISTANCE SYSTEM

(75) Inventors: Pascal Nicolazzi, Gondreville (FR); Bertrand Poirot, Villers Les Nancy (FR); Julien Gentner, Saunay (FR); Philippe Perine, Eulmont (FR)

Correspondence Address: NELLCOR PURITAN BENNETT LLC;ATTN: IP LEGAL, 6135 Gunbarrel Avenue, Boulder, CO, 80301, US

(73) Assignee: Nellcor Puritan Bennett LLC, Boulder, CO (US)

(21) Appl. No.: 12/472,018

(22) Filed: May 26, 2009

(51) Int. Cl. A62B 9/02

(52) U.S. Cl. 128/205.24

(57) ABSTRACT

A breathing assistance system includes a gas delivery system that generates a gas flow, a fluid source (e.g., a humidifier system or supplemental gas supply) located downstream from the gas delivery system that humidifies the gas flow generated by the gas delivery system, a gas flow conduit system for communicating the gas flow from the gas delivery system, and a flow regulation device. The flow regulation device is physically moveable between (a) an operational position that allows the gas flow generated by the gas delivery system to flow downstream past the flow regulation device via the gas flow conduit system, and (b) a protection position that prevents gasses and liquids flowing upstream through the gas flow conduit system from reaching the gas delivery system, and instead directs such gasses and liquids through an exhaust opening in the gas flow conduit system. The flow regulation device automatically moves between the operational position and the protection position based at least on a gas pressure upstream of the flow regulation device.

### TECHNICAL FIELD

The invention relates to systems and methods for preventing damage in a breathing assistance system (e.g., ventilator or CPAP system) having a humidifier.

### BACKGROUND

Many breathing assistance systems (e.g., CPAP devices, mechanical ventilators, etc.) use humidifiers in order to provide humidified air to a patient. Humidification may prevent various conditions, e.g., hypothermia, inspissation of airway secretions, destruction of airway epithelium, and atelectasis.

Humidifiers can be passive or active. Passive humidifiers (e.g., a heat-and-moisture exchanger (HME), which may be referred to as an “artificial nose”) may trap heat and humidity from the patient's exhaled gas and return some of the trapped heat and humidity to the patient during the subsequent inhalation. Active, or heated, humidifiers typically pass the inspired gas through or over a heated water bath to increase the heat and water vapor content of the inspired gas.

In some breathing assistance systems, a humidifier is indirectly connected to a gas delivery system (e.g., a motorized blower, piston-based device, flow-control valves, a compressor, etc.) by one or more tubes or others conduits. In such systems, liquid water from the humidifier may flow into the gas flow generation system when one or both of the humidifier and gas delivery system is lifted, tilted, turned, or otherwise moved, which may damage components of the gas delivery system (e.g., a blower, motor, electronics, etc.) and/or other components of the breathing assistance system. In other breathing assistance systems, a humidifier shares a housing with, or is otherwise physically integrated with, a gas delivery system. In such systems, liquid water from the humidifier may flow into the gas flow generation system when the system is tilted, turned on its side, or turned over, which again may damage components of the gas delivery system and/or other components of the breathing assistance system.

### SUMMARY

In accordance with one embodiment of the present disclosure, a breathing assistance system includes a gas delivery system that generates a gas flow, a fluid source (e.g., a humidifier system or supplemental gas supply) located downstream from the gas delivery system that humidifies the gas flow generated by the gas delivery system, a gas flow conduit system for communicating the gas flow from the gas delivery system, and a flow regulation device. The flow regulation device is physically moveable between (a) an operational position that allows the gas flow generated by the gas delivery system to flow downstream past the flow regulation device via the gas flow conduit system, and (b) a protection position that prevents gasses and liquids flowing upstream through the gas flow conduit system from reaching the gas delivery system, and instead directs such gasses and liquids through an exhaust opening in the gas flow conduit system. The flow regulation device automatically moves between the operational position and the protection position based at least on the gas flow generated by the gas delivery system.

In accordance with another embodiment of the present disclosure, a flow regulation device for use in a breathing assistance system including a gas delivery system configured to generate a gas flow, a fluid source (e.g., a humidifier system or supplemental gas supply) located downstream from the gas delivery system and configured to humidify the gas flow generated by the gas delivery system, and a gas flow conduit system for communicating the gas flow from the gas delivery system The flow regulation device is located along the gas flow conduit system. The flow regulation device is physically moveable between (a) an operational position that allows the gas flow generated by the gas delivery system to flow downstream past the flow regulation device via the gas flow conduit system, and (b) a protection position that prevents gasses and liquids flowing upstream through the gas flow conduit system from reaching the gas delivery system, and directs such gasses and liquids flowing upstream through an exhaust opening in the gas flow conduit system. The flow regulation device automatically moves between the operational position and the protection position based at least on the gas flow generated by the gas delivery system.

In accordance with another embodiment of the present disclosure, a method is provided for protecting a gas delivery system configured to generate a gas flow in a breathing assistance system including the gas delivery system, a fluid source (e.g., a humidifier system or supplemental gas supply) located downstream from the gas delivery system, and a gas flow conduit system for communicating the gas flow from the gas delivery system. The method includes operating the gas delivery system in a first state that causes a flow regulation device to automatically move to an operational position in which (a) the gas flow generated by the gas delivery system is allowed to flow downstream past the flow regulation device via the gas flow conduit system; and (b) an exhaust opening in gas flow conduit system is closed by the flow regulation device. The method further includes adjusting the gas delivery system to a second state that causes the flow regulation device to automatically move to a protection position in which (a) the exhaust opening in gas flow conduit system is not closed by the flow regulation device; and (b) gasses and liquids flowing upstream through the gas flow conduit system are blocked from flowing to the gas delivery system, and instead directed through the exhaust opening in the gas flow conduit system.

### BRIEF DESCRIPTION OF THE DRAWINGS

For a more complete understanding of the present invention, and the advantages thereof, reference may be made to the following description of exemplary embodiments, taken in conjunction with the accompanying drawings, in which:

FIG. 1 illustrates an example breathing assistance system for delivering gas to a patient, including a protection system for preventing damage to a gas flow generation device and/or preventing the accumulation of combustible or otherwise potentially dangerous gasses (e.g., O₂), according to certain embodiments of the disclosure;

FIGS. 2A and 2B illustrate an operational position and a protection position, respectively, of a flow regulating device of the protection system of the system of FIG. 1, according to certain embodiments of the disclosure;

FIG. 3 illustrates an example breathing assistance system including a gas delivery system, a humidifier, and a protection system for preventing water from the humidifier from back-flowing into the gas delivery system, according to certain embodiments of the disclosure;

FIG. 4 illustrates an example breathing assistance system including a gas delivery system, a supplemental gas flow (e.g., O₂), and a protection system for preventing the supplemental gas flow from accumulating in the gas delivery system, according to certain embodiments of the disclosure; and

FIG. 5 illustrates a method for preventing damage to a gas flow generation device and/or preventing the accumulation of combustible or otherwise potentially dangerous gasses (e.g., O₂), according to certain embodiments of the disclosure.

### DETAILED DESCRIPTION OF THE DRAWINGS

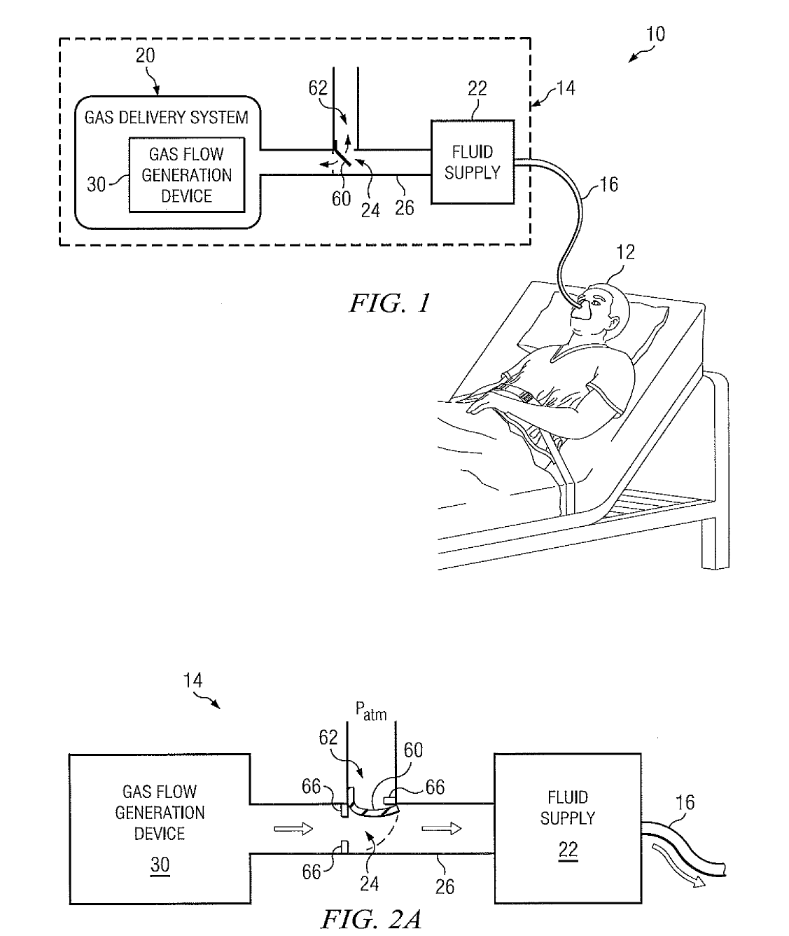

Selected embodiments of the disclosure may be understood by reference, in part, to FIGS. 1-5, wherein like numbers refer to same and like parts. The present disclosure relates generally to breathing assistance systems including integrated or attachable humidifiers, e.g., for providing CPAP therapy, ventilation, or other breathing assistance to patients. A breathing assistance system (e.g., a CPAP device or ventilator) may include a gas delivery system for generating a gas flow (e.g., a pressurized air flow) and a humidifier system for humidifying the gas flow before the gas is delivered to a patient, e.g., via a patient circuit. A flow regulation device is physically moveable between an operational position that allows the gas flow generated by the gas delivery system to flow downstream past the flow regulation device via the gas flow conduit system, and a protection position that prevents gasses and liquids flowing upstream through the gas flow conduit system from reaching the gas delivery system, and instead directs such gasses and liquids through an exhaust opening in the gas flow conduit system. The flow regulation device automatically moves between the operational position and the protection position based at least on the gas flow generated by the gas delivery system.

FIG. 1 illustrates an example system 10 for delivering humidified gas to a patient 12, according to one embodiment of the disclosure. System 10 may include a breathing assistance system 14 for generating a gas flow, and a connection system 16 for delivering the gas flow to patient 12.

Breathing assistance system 14 may comprise any device, apparatus, or system for generating a gas flow to be delivered to a patient, e.g., a ventilator, a respirator, a CPAP device, or a BiPAP device. Breathing assistance system 14 may include a gas delivery system 20, one or more fluid sources 22, a protection system 24, and a conduit system 26. Gas delivery system 20 may include a gas flow generation device 30 configured to generate, supply, and/or deliver gas (e.g., pressurized air) toward patient 12. For example, gas flow generation device 30 may comprise a device capable of generating pressurized air (e.g., a motorized blower or piston-based device), a wall outlet through which pressurized air may be supplied (e.g., in a hospital or clinic) and/or conduits for communicating air from a wall outlet, valves configured to control the supply of gas to the patient (e.g., a PSOL or other solenoid valve), one or more tanks of compressed gas, a compressor, and/or any other suitable source of pressurized or non-pressurized gas. In certain embodiments, gas flow generation device 30 includes a blower including an electric motor and other suitable electronics.

As used herein, the term “gas” may refer to any one or more gases and/or vaporized substances suitable to be delivered to and/or from a patient via one or more breathing orifices (e.g., the nose and/or mouth), such as air, nitrogen, oxygen, any other component of air, CO₂, vaporized water, vaporized medicines, and/or any combination of two or more of the above, for example.

As used herein, the term “patient” may refer to any person or animal that may receive breathing assistance from system 10, regardless of the medical status, official patient status, physical location, or any other characteristic of the person. Thus, for example, patients may include persons under official medical care (e.g., hospital patients), persons not under official medical care, persons receiving care at a medical care facility, persons receiving home care, etc.

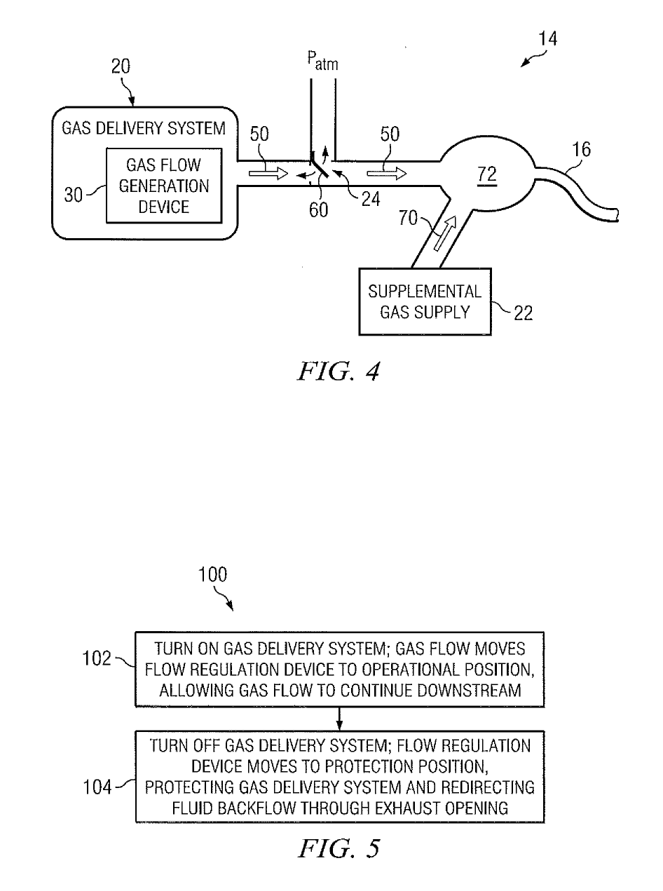

Each fluid source 22 may include any source of a gas or liquid introduced into conduit system 26 downstream of gas delivery system 20 and protection system 24. Example fluid sources 22 may include a humidifier system (e.g., as shown in FIG. 3), a supplemental gas supply (e.g., as shown in FIG. 4), or any other gas or liquid source. Each fluid source 22 may be permanently or removably attached to gas delivery system 20 and/or conduit system 26. For example, each fluid source 22 may be physically integrated with, directly connected to, or indirectly connected to gas delivery system 20 and/or conduit system 26.

Protection system 24 is located along conduit system 26 between gas delivery system 20 and fluid source(s) 22 such that the gas flow generated by gas flow generation device 30 flows through protection system 24, is affected by one or more fluid source 22 (e.g., the gas flow is humidified and/or mixed with a supplemental gas flow), and flows through connection system 16 toward patient 12. In general, protection system 24 prevents fluids, from one or more fluid source 22 and/or other source, from flowing upstream and into gas delivery system 20, thereby protecting components of gas delivery system 20 (e.g., gas flow generation device 30) from damage and/or preventing the accumulation of combustible or otherwise potentially dangerous gasses (e.g., O₂) in gas delivery system 20.

In some embodiments, protection system 24 includes a flow regulation device 60 that is physically moveable between (a) an operational position that allows the gas flow generated by gas delivery system 20 to flow downstream past protection system 24 and to fluid source(s) 22 via conduit system 26, and (b) a protection position that prevents fluids (gasses and liquids) flowing upstream through conduit system 26 from reaching gas delivery system 20, and instead directs such upstream-flowing fluids through an exhaust opening 62 in conduit system 26. Exhaust opening 62 may open to the ambient environment (e.g., atmospheric pressure).

Flow regulation device 60 automatically moves between the operational and protection positions based at least on the gas flow generated by gas delivery system 20. For example, in some embodiments, flow regulation device 60 is maintained in the protection position (preventing upstream flow) when the gas delivery system is turned off or generating a gas flow below a threshold pressure, moves to the operational position (allowing downstream gas flow) when gas delivery system 20 is turned on and generating a gas flow above the threshold pressure. In some embodiments, the threshold pressure is the pressure required to physically move a flow regulation device 60. For example, in embodiments in which flow regulation device 60 is maintained in the protection position by a spring force or other mechanically resistive force, the threshold pressure may be defined as the pressure that exceeds the ambient pressure (e.g., atmospheric pressure) by an amount equal to the spring/resistive force provided by regulation device 60.

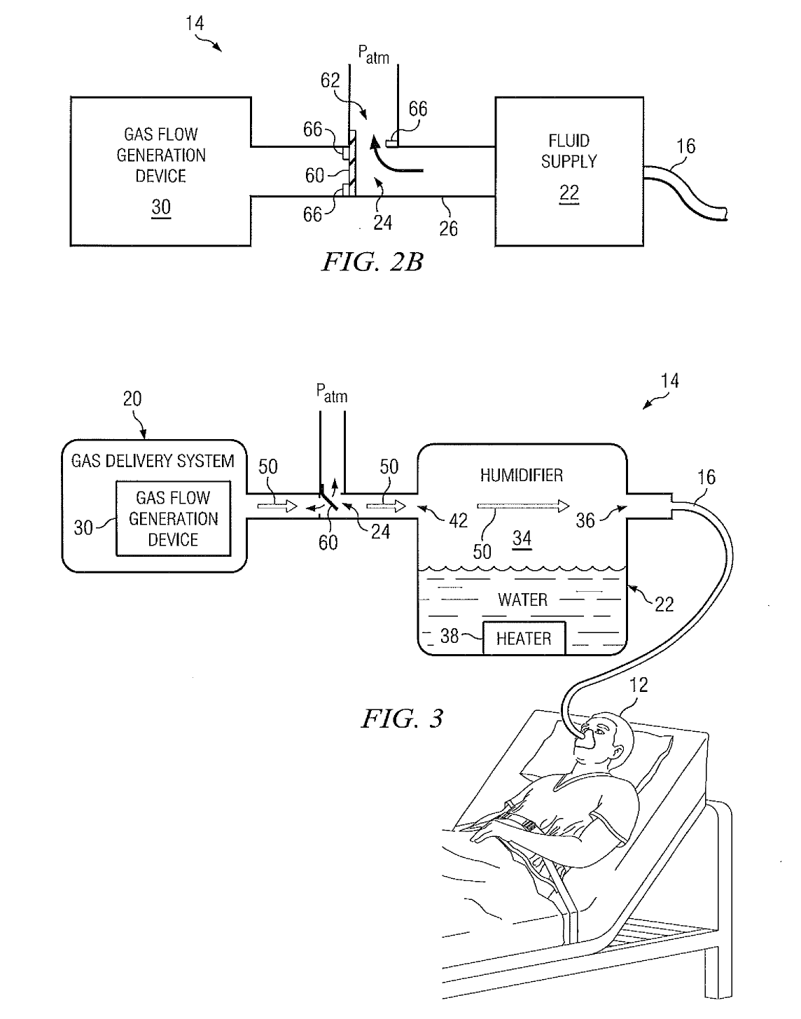

FIGS. 2A and 2B illustrate the operational and protection positions, respectively, of an example flow regulation device 60. In this example, flow regulation device 60 is a flexible member that flexes between the operational and protection positions. In the operational position, as shown in FIG. 2A, gas delivery system 20 is turned on and generating a gas flow sufficient to overcome a spring force provided by flexible regulation device 60, thus causing regulation device 60 to flex away from the gas flow. In this embodiment, flexible regulation device 60 in its operational position completely blocks exhaust opening 62 in conduit system 26, such that the entire gas flow is delivered downstream past protection system 24. However, in other embodiments, flexible regulation device 60 in its operational position may only partially block exhaust opening 62.

In the protection position of flow regulation device 60, as shown in FIG. 2A, gas delivery system 20 is turned off or generating a gas flow not sufficient to overcome the spring force provided by flexible regulation device 60, thus causing regulation device 60 to return to its unflexed position. In the unflexed position, flow regulation device 60 blocks conduit system 26 from upstream flow, thereby protecting components of gas delivery system 20 from damage and/or preventing the accumulation of combustible or otherwise potentially dangerous gasses (e.g., O₂) in gas delivery system 20. In this position, exhaust opening 62 is partially or completely uncovered by flow regulation device 60 such that fluid flowing upstream toward gas delivery system 20 is redirected out through exhaust opening 62.

Flow regulation device 60 may formed a sealed connection with conduit system 26 in order to completely or substantially completely block gas and liquid flow. Conduit system 26 may include one or more flanges 66 or other contacting surfaces around an inner perimeter of conduit system 26 to increase the area of contact area with flow regulation device 60 and/or to prevent flow regulation device 60 from over-flexing backwards toward gas delivery system 20. Flow regulation device 60 and/or flange 66 may be made from any suitable material and include any suitable mechanism to increase the sealing force between flow regulation device 60 and flange 66. For example, flow regulation device 60 and/or flange 66 may be formed from materials that form an adhesive force between the two. For example, flow regulation device 60 or flange 66 may include magnets around the perimeter configured to mate with metal disposed around the perimeter of the other.

In other embodiments, flow regulation device 60 may comprise a substantially rigid valve member that pivots between the operational and protection positions. Such device 60 may include one or more physical springs that bias the valve member toward the protection position. Again, flow regulation device 60 and/or flange 66 may be made from any suitable material and include any suitable mechanism to increase the sealing force between flow regulation device 60 and flange 66, such as those discussed above.

Flow regulation device 60, whether flexible or substantially rigid, may have any suitable size and shape. For example, the cross-section of flow regulation device 60 preferably matches the cross-section of the conduit in which it is housed, which cross-section may have a circular, elliptical, rectangular, square (or any other polygon), or any other suitable shape. Flow regulation device 60 is preferable formed from gas- and liquid-impermeable material(s), e.g., plastic, glass, metal, etc.

In some embodiments (e.g., FIGS. 1-4), protection system 24 is located between gas delivery system 30 and fluid source(s) 22. In other embodiments, protection system 24 is at least partially integrated with gas delivery system 20. In still other embodiments, protection system 24 is at least partially integrated with a fluid source 22. In still other embodiments, protection system 24 at least partially integrated with both gas delivery system 20 and a fluid source 22.

Breathing assistance system 14 may also include any other suitable components for providing breathing assistance to patient 12. For example, breathing assistance system 14 may include one or more sensors for sensing, detecting, and/or monitoring one or more parameters related to system 10 and/or patient 12, a control system for controlling gas delivery system 20, various user interfaces, and a display.

Connection system 16 may be generally configured to deliver gas from breathing assistance system 14 to patient 12 and/or to remove exhaust gas away from patient 12. For example, connection system 16 may comprise any suitable type of breathing circuit (e.g., a single-limb or dual-limb circuit) and/or a patient connection apparatus. A patient connection apparatus may include any device or devices configured to connect the breathing circuit to one or more breathing passageways of patient 12. For example, a patient connection apparatus may include a patient connection tube directly connected to the patient's trachea, an artificial airway (e.g., an endotracheal tube or other device) inserted in the patient's trachea, and/or a mask, cushion or nasal pillows positioned over the patient's nose and/or mouth. Connection system 16 may be directly or indirectly coupled to breathing assistance system 14 in any suitable manner.

FIG. 3 illustrates an example breathing assistance system 14 including a gas delivery system 20, a humidifier 22, and a protection system 24 for preventing water from humidifier 22 from back-flowing into gas delivery system 20, according to certain embodiments of the disclosure.

Humidifier 22 is generally operable to humidify (e.g., to increase the heat and/or water vapor content) a gas flow from gas delivery system 20 to then be delivered to patient 12 via connection system 16. Humidifier 22 may or may not be a heated humidifier. Humidifier 22 may be permanently or removably attached to gas delivery system 20. In some embodiments, humidifier 22 is physically integrated with gas delivery system 20. Humidifier 22 may be physically connected to gas delivery system 20 via conduit system 26.

Humidifier 22 may include a liquid water chamber 34 configured to hold liquid water, and an outlet 36 for communicating humidified gas to connection system 16. Liquid water chamber 34 may have any suitable shape and configuration and may be configured to hold any suitable volume of liquid water. In embodiments in which humidifier 22 is a heated humidifier, humidifier 22 may include a heater 38 and any suitable electronics (an electrical, gas, or battery-powered heating device). Humidifier 22 may be directly or indirectly coupled to connection system 16 in any suitable manner. In some embodiments, outlet 36 defines an outlet from breathing assistance system 14, such that connection system 16 may be coupled directly to outlet 36. In other embodiments, outlet 36 of humidifier 22 may open to one or more other internal chambers or conduits of breathing assistance system 14, which may in turn lead to an outlet from breathing assistance system 14 to which connection system 16 may be connected.

When gas flow generation device 30 is turned on, a generated gas flow 50 may flow through conduit system 26, forcing flow regulation device 60 to move to the operational position. The operational position allows the gas flow 50 to flow to humidifier 22, where the gas flow may then flow through gas inlet 42, into liquid water chamber 34, become humidified by liquid water in chamber 34, and then flow out through outlet 36 towards patient 12. In some embodiments, the humidification may be promoted by a heater 38.

When gas flow generation device 30 is turned off, flow regulation device 60 automatically moves (e.g., flexes or pivots) back to its protection position, e.g., due to spring forces acting on flow regulation device 60. As discussed above, the protection position of flow regulation device 60 prevents fluids from passing upstream to gas flow generation device 30. Thus, if humidifier 22 is tilted, turned, flipped, or otherwise moved (e.g., during transportation of system 14) such that water spills out through gas inlet 42 and towards gas flow generation device 30, flow regulation device 60 acts as a liquid barrier to substantially prevent the water from reaching gas flow generation device 30. Such water is instead directed out through exhaust opening 62 in conduit system 26.

FIG. 4 illustrates an example breathing assistance system 14 including a gas delivery system 20, a supplemental gas supply 22, and a protection system 24 for preventing the supplemental gas flow from supplemental gas supply 22 from accumulating in gas delivery system 20, according to certain embodiments of the disclosure.

Supplemental gas supply 22 may comprise any device, apparatus, or system for supplying a supplementary gas (e.g., O₂) to be mixed with the gas flow (e.g., air) provided by gas flow generation device 30. For example, supplemental gas supply 22 may comprise a wall outlet through which a supplementary gas may be supplied (e.g., in a hospital or clinic) and/or conduits for communicating air from a wall outlet, valves configured to control the supply of a supplementary gas (e.g., a PSOL or other solenoid valve), one or more tanks of compressed gas, a compressor, and/or any other suitable source of pressurized or non-pressurized gas.

Supplemental gas supply 22 may supply a supplemental gas flow 70 that mixes with the main gas flow 50 from gas flow generation device 30 at a mixing area 72 before being delivered to patient 12. When gas flow generation device 30 is turned on, gas flow 50 may flow through conduit system 26, forcing flow regulation device 60 to move to the operational position. The operational position allows the gas flow 50 to flow downstream via conduit system 26 to mixing area 72, where it mixes with supplemental gas flow 70 before being delivered to patient 12 via connection system 16.

When gas flow generation device 30 is turned off, flow regulation device 60 automatically moves (e.g., flexes or pivots) back to its protection position, e.g., due to spring forces acting on flow regulation device 60. As discussed above, the protection position of flow regulation device 60 may prevent gasses from passing upstream toward gas flow generation device 30. Thus, if supplemental gas supply 22 continues to supply a supplemental gas flow (e.g., where supplemental gas supply 22 malfunctions or leaks), flow regulation device 60 acts as a barrier to substantially prevent the supplemental gas from accumulating in gas delivery system 20, and instead directs the supplemental gas out through exhaust opening 62.

FIG. 5 illustrates an example method for protecting a gas delivery system 20 of a breathing assistance system 14 having a fluid source 22 (e.g., humidifier or supplemental gas supply 22) from water damage or unwanted gas accumulation, according to certain embodiments of the disclosure.

At step 100, breathing assistance system 14 is operated to deliver gas toward a patient 12. In particular, gas delivery system 20 generates a gas flow, which forces flow regulation device 60 to the operational position, which allows the gas flow to continue downstream via conduit system 26 to fluid supply 22, and which partially or completely blocks exhaust opening 62 in conduit system 26. The gas then flows toward patient 12 via connection system 16.

At step 102, breathing assistance system 14 is turned off, which causes flow regulation device 60 to move to its protection position, which blocks upstream fluid flow through conduit system 26 to gas delivery system 20, and which partially or completely uncovers exhaust opening 62 in conduit system 26. Upstream-owing fluids (e.g., water from humidifier 22 and/or a supplemental gas supply 22) are prevented by flow regulation device 60 from reaching gas delivery system 20, and instead redirected out through exhaust opening 62, thereby protecting the components of gas delivery system 20 (e.g., a motorized blower) from damage and/or preventing an accumulation of combustible or otherwise potentially dangerous gasses (e.g., O₂) in gas delivery system 20.

It will be appreciated that while the disclosure is particularly described in the context of breathing assistance systems, the apparatuses, techniques, and methods disclosed herein may be similarly applied in other contexts. Additionally, it should be understood that various changes, substitutions and alterations can be made herein without departing from the spirit and scope of the disclosure as illustrated by the following claims.

What is claimed is:

1. A breathing assistance system, comprising:
a gas delivery system configured to generate a gas flow;
a fluid source located downstream from the gas delivery system;
a gas flow conduit system for communicating the gas flow between the gas delivery system and the fluid source, the gas flow conduit system including an exhaust opening; and
a flow regulation device associated with the gas flow conduit system, the flow regulation device physically moveable between:
an operational position that allows the gas flow generated by the gas delivery system to flow downstream past the flow regulation device via the gas flow conduit system; and
a protection position that prevents gasses and liquids flowing upstream through the gas flow conduit system from reaching the gas delivery system, and directs such gasses and liquids flowing upstream through the exhaust opening in the gas flow conduit system;
wherein the flow regulation device automatically moves between the operational position and the protection position based at least on the gas flow generated by the gas delivery system.

2. A breathing assistance system according to claim 1, wherein the fluid source comprises a humidifier.

3. A breathing assistance system according to claim 1, wherein the flow regulation device comprises a flexible member that flexes between the operational and protection positions.

4. A breathing assistance system according to claim 1, wherein the flow regulation device comprises a substantially rigid member that pivots between the operational and protection positions.

5. A breathing assistance system according to claim 1, wherein in the operational position of the flow regulation device, the flow regulation device closes the exhaust opening in the gas flow conduit system.

6. A breathing assistance system according to claim 1, wherein the flow regulation device includes a single member that closes off the exhaust opening in the gas flow conduit system in the operational position and closes off the gas flow conduit system in the protection position.

7. A breathing assistance system according to claim 1, wherein the flow regulation device moves between the operational position and the protection position based on a difference in gas pressure acting on an upstream side of the flow regulation device and gas pressure acting on a downstream side of the flow regulation device.

8. A breathing assistance system according to claim 1, wherein:
the exhaust opening in the gas flow conduit system opens to an ambient pressure;
the flow regulation device is maintained in the protection position when the gas delivery system is turned off; and
the flow regulation device moves to the operational position when the gas delivery system is turned on and the pressure of the gas flow generated by the gas delivery system exceeds the ambient pressure by an amount sufficient to overcome a spring force required to move the flow regulation device.

9. A breathing assistance system according to claim 1, wherein:
the flow regulation device moves to the operational position when the gas delivery system is generating a gas flow; and
the flow regulation device moves to the protection position when the gas delivery system is not generating a gas flow.

10. A breathing assistance system according to claim 1, wherein the fluid source is physically integrated with the gas delivery system.

11. A breathing assistance system according to claim 1, wherein the breathing assistance system comprises a portable CPAP device or a portable ventilator.

12. A breathing assistance system according to claim 1, wherein:
the fluid source comprises a supplemental gas supply system for supplying a supplemental gas flow that is mixed with the gas flow generated by the gas delivery system for delivery of the mixed gas to a patient; and
the supplemental gas flow mixes with the gas flow generated by the gas delivery system at a location downstream of the flow regulation device and the exhaust opening in the gas flow conduit system such that in the protection position of the flow regulation device, the supplemental gas flow is prevented from flowing upstream into the gas delivery system and instead directed through the exhaust opening in the gas flow conduit system.

13. A breathing assistance system according to claim 1, wherein the flow regulation device is physically integrated with the gas delivery system, physically integrated with the fluid supply, physically integrated with both the gas delivery system and the fluid supply, or located between the gas delivery system and the fluid supply.

14. A flow regulation device for use in a breathing assistance system including a gas delivery system configured to generate a gas flow, a fluid source located downstream from the gas delivery system and configured to humidify the gas flow generated by the gas delivery system, and a gas flow conduit system for communicating the gas flow from the gas delivery system;
wherein the flow regulation device is located along the gas flow conduit system;
wherein the flow regulation device is physically moveable between:
an operational position that allows the gas flow generated by the gas delivery system to flow downstream past the flow regulation device via the gas flow conduit system; and
a protection position that prevents gasses and liquids flowing upstream through the gas flow conduit system from reaching the gas delivery system, and directs such gasses and liquids flowing upstream through an exhaust opening in the gas flow conduit system; and
wherein the flow regulation device automatically moves between the operational position and the protection position based at least on the gas flow generated by the gas delivery system.

15. A flow regulation device according to claim 14, wherein the flow regulation device comprises a flexible member that flexes between the operational and protection positions.

16. A flow regulation device according to claim 14, wherein the flow regulation device comprises a substantially rigid member that pivots between the operational and protection positions.

17. A flow regulation device according to claim 14, wherein in the operational position of the flow regulation device, the flow regulation device closes the exhaust opening in the gas flow conduit system.

18. A flow regulation device according to claim 14, wherein:
the exhaust opening in the gas flow conduit system opens to an ambient pressure;
the flow regulation device is maintained in the protection position when the gas delivery system is turned off; and
the flow regulation device moves to the operational position when the gas delivery system is turned on and the pressure of the gas flow generated by the gas delivery system exceeds the ambient pressure by an amount sufficient to overcome a spring force required to move the flow regulation device.

19. A flow regulation device according to claim 14, wherein:
the flow regulation device moves to the operational position when the gas delivery system is on; and
the flow regulation device moves to the protection position when the gas delivery system is off.

20. A method for protecting a gas delivery system configured to generate a gas flow in a breathing assistance system including the gas delivery system, a fluid source located downstream from the gas delivery system, and a gas flow conduit system for communicating the gas flow from the gas delivery system, the method comprising:
operating the gas delivery system in a first state that causes a flow regulation device to automatically move to an operational position in which:
the gas flow generated by the gas delivery system is allowed to flow downstream past the flow regulation device via the gas flow conduit system; and
an exhaust opening in gas flow conduit system is closed by the flow regulation device; and
adjusting the gas delivery system to a second state that causes the flow regulation device to automatically move to a protection position in which:
the exhaust opening in gas flow conduit system is not closed by the flow regulation device; and
gasses and liquids flowing upstream through the gas flow conduit system are blocked from flowing to the gas delivery system, and instead directed through the exhaust opening in the gas flow conduit system.

21. A method according to claim 20, wherein:
the exhaust opening in the gas flow conduit system opens to an ambient pressure;
operating the gas delivery system in a first state that causes a flow regulation device to automatically move to an operational position comprises operating the gas delivery system such that the pressure of the gas flow generated by the gas delivery system exceeds the ambient pressure by an amount sufficient to overcome a spring force required to move the flow regulation device; and
adjusting the gas delivery system to a second state that causes the flow regulation device to automatically move to a protection position comprises turning off the gas delivery system.
